(19) United States
(12) Patent Application Publication
(10) Pub. No.: US 2011/0017942 A1
(43) Pub. Date: Jan. 27, 2011

(54) PENTAFLUOROETHANE, TETRAFLUOROETHANE AND N-BUTANE COMPOSITIONS

(75) Inventors: Donald Bernard Bivens, Kennett Square, PA (US); Deepak Perti, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, WILMINGTON, DE (US)

(21) Appl. No.: 12/922,228

(22) PCT Filed: Apr. 10, 2009
(86) PCT No.: PCT/US09/40134

§ 371 Date: Sep. 13, 2010

Related U.S. Application Data
(60) Provisional application No. 61/045,026, filed on Apr. 15, 2008.

(51) Int. Cl. C09K 5/04

(52) U.S. Cl. 252/68; 252/67

(57) ABSTRACT

Disclosed are compositions containing about 17.0 weight percent to about 22.0 weight percent pentafluoroethane; about 77.0 weight percent to about 81.0 weight percent 1,1,1,2-tetrafluoroethane; and about 1.0 weight percent to about 2.0 weight percent of n-butane, and which may include optional other components.

### FIELD OF THE DISCLOSURE

The disclosed compositions relate to compositions that contain pentafluoroethane, tetrafluoroethane, and n-butane and their use.

### BACKGROUND

The cooling and heating industry has been responding to environmental needs and regulations by providing heat transfer compositions that do not deplete the ozone layer for almost a decade.

Many alternative refrigerant blends have been proposed that function well as refrigerants. Yet, some of these blends have limitations with respect to the use of the conventional refrigeration lubricants, such as mineral oil. Many hydrofluorocarbon blends have low solubilities in mineral oil and alkylbenzene lubricants thus requiring that alternative lubricants be used. Additionally, when retrofitting existing equipment with a hydrofluorocarbon based refrigerant, removal of the original, often unacceptable lubricant is necessary, which leads to time consuming and costly flushing of the system to remove residual lubricant. Certain refrigerant blends containing hydrocarbons have been proposed for improving the solubility with mineral oils and alkylbenzene lubricants. However, many of these hydrocarbon containing refrigerant blends may be flammable, either as originally formulated in the liquid or vapor phase or may produce flammable mixtures upon leakage from a heat transfer system or from refrigerant storage containers. Therefore, only those blends that have been found to be non-flammable are widely accepted. These blends often do not contain enough hydrocarbon to improve the solubility with mineral oil or alkylbenzene lubricants to the degree necessary to allow the use of such blends with these type of lubricants, while achieving the other desirable properties for the heat transfer compositions.

Thus, there remains a need for alternative compositions useful as heat transfer compositions that achieve a balance of properties and performance needs. Such properties and performance characteristics that need to be balanced may include non-flammability, heat transfer capacity, environmental goals, effects in equipment, and system energy efficiency, to name a few.

### SUMMARY OF THE INVENTION

Therefore, in accordance with the present invention, there are provided compositions consisting essentially of about 1.0 weight percent to about 22.0 weight percent pentafluoroethane (also known as HFC-125, R125 or CF₃CHF₂); about 77.0 weight percent to about 81.0 weight percent 1,1,1,2-tetrafluoroethane (also known as HFC-134a, R134a or CF₃CH₂F); and about 1.0 weight percent to about 2.0 weight percent of n-butane (also known as R600 or CH₃CH₂CH₂CH₃), and which may include optional other components.

Further disclosed are compositions consisting essentially of about 18.0 weight percent to about 21.0 weight percent pentafluoroethane; about 77.4 weight percent to about 80.4 weight percent 1,1,1,2-tetrafluoroethane; and about 1.2 weight percent to about 1.9 weight percent of n-butane, and which may include optional other components.

In other embodiments, the compositions consist essentially of about 18.5 weight percent to about 20.5 weight percent pentafluoroethane; about 77.9 weight percent to about 79.9 weight percent 1,1,1,2-tetrafluoroethane; and about 1.3 weight percent to about 1.8 weight percent of n-butane, and which may include optional other components.

In some embodiments, the compositions consist essentially of about 19.0 weight percent to about 20.0 weight percent pentafluoroethane; about 78.4 weight percent to about 79.4 weight percent 1,1,1,2-tetrafluoroethane; and about 1.4 weight percent to about 1.7 weight percent of n-butane, and which may include optional other components.

Further disclosed is a heat transfer system comprising a composition disclosed herein, wherein said system is selected from the group consisting of air-conditioners, freezers, refrigerators, heat pumps, water chillers, flooded evaporator chillers, direct expansion chillers, walk-in coolers, heat pumps, mobile refrigerators, mobile air conditioning units and combinations thereof.

### DESCRIPTION OF THE INVENTION

In accordance with the present invention, disclosed are compositions consisting essentially of about 1.0 weight percent to about 22.0 weight percent pentafluoroethane (also known as HFC-125, R125 or CF₃CHF₂); about 77.0 weight percent to about 81.0 weight percent 1,1,1,2-tetrafluoroethane (also known as HFC-134a, R134a or CF₃CH₂F); and about 1.0 weight percent to about 2.0 weight percent of n-butane (also known as R600 or CH₃CH₂CH₂CH₃), and which may include optional other components.

Further disclosed are compositions consisting essentially of about 18.0 weight percent to about 21.0 weight percent pentafluoroethane; about 77.4 weight percent to about 80.4 weight percent 1,1,1,2-tetrafluoroethane; and about 1.2 weight percent to about 1.9 weight percent of n-butane, and which may include optional other components.

In other embodiments, the compositions consist essentially of about 18.5 weight percent to about 20.5 weight percent pentafluoroethane; about 77.9 weight percent to about 79.9 weight percent 1,1,1,2-tetrafluoroethane; and about 1.3 weight percent to about 1.8 weight percent of n-butane, and which may include optional other components.

In some embodiments, the compositions consist essentially of about 19.0 weight percent to about 20.0 weight percent pentafluoroethane;

about 78.4 weight percent to about 79.4 weight percent 1,1,1,2-tetrafluoroethane; and about 1.4 weight percent to about 1.7 weight percent of n-butane, and which may include optional other components.

Further disclosed is a heat transfer system comprising a composition disclosed herein, wherein said system is selected from the group consisting of air-conditioners, freezers, refrigerators, heat pumps, water chillers, flooded evaporator chillers, direct expansion chillers, walk-in coolers, heat pumps, mobile refrigerators, mobile air conditioning units and combinations thereof.

The compositions disclosed herein are useful as heat transfer compositions, aerosol propellant, foaming agents, blowing agents, solvents, cleaning agents, carrier fluids, displacement drying agents, buffing abrasion agents, polymerization media, expansion agents for polyolefins and polyurethane, gaseous dielectrics, extinguishing agents, and fire suppression agents in liquid or gaseous form. The disclosed compositions can act as a working fluid used to carry heat from a heat source to a heat sink. Such heat transfer compositions may also be useful as a refrigerant in a cycle wherein the fluid undergoes phase changes; that is, from a liquid to a gas and back or vice versa.

In some embodiments, the optional other components may be an additive. In some embodiments, in the compositions disclosed herein may further contain one or more additive selected from the group consisting of lubricants, dyes, solubilizing agents, compatibilizers, stabilizers, tracers, perfluoropolyethers, anti wear agents, extreme pressure agents, corrosion and oxidation inhibitors, metal surface energy reducers, metal surface deactivators, free radical scavengers, foam control agents, viscosity index improvers, pour point depressants, detergents, viscosity adjusters, and mixtures thereof. Indeed, many of these additional components fit into one or more of these categories and may have qualities that lend themselves to achieve one or more performance characteristic.

In some embodiments, one or more additive is present in the compositions disclosed in small amounts relative to the overall composition. In some embodiments, the total amount of the additive component whether comprising one or more than one additive in the disclosed compositions is from less than about 0.1. In some embodiments, the total amount of the additive component whether comprising one ore more than one additive in the disclosed compositions is from about 0.1 weight percent to as much as about 5.0 weight percent of total additive. In some the additives are present in the disclosed compositions in an amount between about 0.1 weight percent to about 3.5 weight percent. The additive components selected for the disclosed composition is selected on the basis of the utility and/or individual equipment components or the system requirements.

In some embodiments, the disclosed compositions further include at least one lubricant selected from the group consisting of mineral oils (oils of mineral origin), synthetic lubricants, and mixtures thereof.

In some embodiments, the disclosed compositions include at least one lubricant selected from those suitable for use with refrigeration or air-conditioning equipment. In some embodiments, the disclosed compositions include at least one synthetic oil selected from those readily known in the field of compression refrigeration lubrication.

In some embodiments, at least one optional component is a mineral oil lubricant. In some embodiments, the mineral oil lubricant is selected from the group consisting of paraffins (including straight carbon chain saturated hydrocarbons, branched carbon chain saturated hydrocarbons, and mixtures thereof), naphthenes (including saturated cyclic and ring structures), aromatics (those with unsaturated hydrocarbons containing one or more ring, wherein one or more ring is characterized by alternating carbon-carbon double bonds) and non-hydrocarbons (those molecules containing atoms such as sulfur, nitrogen, oxygen and mixtures thereof), and mixtures and combinations of thereof.

Some embodiments may contain one or more synthetic lubricant. In some embodiments, the synthetic lubricant is selected from the group consisting of alkyl substituted aromatics (such as benzene or naphthalene substituted with linear, branched, or mixtures of linear and branched alkyl groups, often generically referred to as alkylbenzenes), synthetic paraffins and naphthenes, poly (alpha olefins), polyglycols (including polyalkyene glycols), dibasic acid esters, polyesters, neopentyl esters, polyvinyl ethers (PVEs), silicones, silicate esters, fluorinated compounds, phosphate esters and mixtures and combinations thereof. In some embodiments, the compositions disclosed herein contain at least one commercially available lubricant. In some embodiments the compositions disclosed herein contain at least one lubricant selected from the group consisting of BVM 100 N (paraffinic mineral oil sold by BVA Oils), those sold under the trademarks Suniso® 1GS, Suniso® 3GS and Suniso® 5GS (naphthenic mineral oils sold by Crompton Co.), those sold under the trademark Sontex® 372LT (naphthenic mineral oil sold by Pennzoil), those sold under the trade mark Calumet® RO-30 (naphthenic mineral oil sold by Calumet Lubricants), those sold under the trademarks Zerol® 75, Zerol® 150 and Zerol® 500 (linear alkylbenzenes sold by Shrieve Chemicals) and HAB 22 (branched alkylbenzene sold by Nippon Oil), polyol esters (POEs) such as those sold under the trademark Castrol® 100 (Castrol, United Kingdom), polyalkylene glycols (PAGs) such as RL-488A from Dow (Dow Chemical, Midland, Mich.), and mixtures thereof.

In other embodiments, at least one of the lubricants further include those lubricants that have been designed for use with hydrofluorocarbon refrigerants and are miscible with compositions as disclosed herein under vapor compression refrigeration and air-conditioning apparatus' operating conditions. In some embodiments, the lubricants are selected by considering a given compressor's requirements and the environment to which the lubricant will be exposed.

In some embodiments, the lubricant is present in an amount of less than 5.0 weight % to the total composition. In other embodiments, the amount of lubricant is between about 0.1 and 3.5 weight % of the total composition.

Notwithstanding the above weight ratios for compositions disclosed herein, it is understood that in some heat transfer systems, while the composition is being used, it may acquire additional lubricant from one or more equipment components of such heat transfer systems. For example, in some refrigeration, air conditioning and heat pump systems, lubricants may be charged in the compressor and/or the compressor lubricant sump. Such lubricant would be in addition to any lubricant additive present in the refrigerant in such a system. In use, the refrigerant composition when in the compressor may pick up an amount of the equipment lubricant to change the refrigerant's composition from its pre-use composition.

In such heat transfer systems, even when the majority of the lubricant resides within the compressor portion of the system, the entire system may contain a total composition with as much as about 75 weight percent to as little as about 1.0 weight percent of the composition being lubricant. In one embodiment, in some systems, for example supermarket refrigerated display cases, the system may contain about 3 weight percent lubricant (over and above any lubricant present in the refrigerant composition prior to charging the system) and 97 weight percent refrigerant. In another embodiment, in some heat transfer systems, for example mobile air conditioning systems, the system may contain about 20 weight percent lubricant (over and above any lubricant present in the refrigerant composition prior to charging the system) and about 80 weight percent refrigerant.

In some embodiments, the disclosed compositions further include at least one dye. In some embodiments, the disclosed compositions include at least one ultra-violet (UV) dye.

In some embodiments, the disclosed compositions include at least one UV dye that is a fluorescent dye. In some embodiments, the described compositions include at least one UV dye that is a fluorescent dye selected from the group consisting of naphthalimides, perylenes, coumarins, anthracenes, phenanthracenes, xanthenes, thioxanthenes, naphthoxanthenes, fluoresceins, and derivatives of said dye and combinations thereof.

In some embodiments, the disclosed compositions contain from about 0.001 weight percent to about 1.0 weight percent UV dye. In other embodiments, the UV dye is present in an amount of from about 0.005 weight percent to about 0.5 weight percent; and in other embodiments, the UV dye is present in an amount of from 0.01 weight percent to about 0.25 weight percent of the total composition.

In some embodiments, the UV dye is a useful component for detecting leaks of the composition by permitting one to observe the fluorescence of the dye at or in the vicinity of a leak point in an apparatus (e.g., refrigeration unit, air-conditioner or heat pump). One may observe the UV emission, e.g., fluorescence from the dye under an ultra-violet light. Therefore, if a composition containing such a UV dye is leaking from a given point in an apparatus, the fluorescence can be detected at the leak point, or in the vicinity of the leak point.

In some embodiments, the described compositions further contain at least one solubilizing agent selected to improve the solubility of one or more dye in the disclosed compositions. In some embodiments, the weight ratio of dye to solubilizing agent ranges from about 99:1 to about 1:1.

In some embodiments, solubilizing agents in the disclosed compositions include at least one compound selected from the group consisting of hydrocarbons, hydrocarbon ethers, polyoxyalkylene glycol ethers (such as dipropylene glycol dimethyl ether), amides, nitriles, ketones, chlorocarbons (such as methylene chloride, trichloroethylene, chloroform, or mixtures thereof), esters, lactones, aromatic ethers, fluoroethers and 1,1,1-trifluoroalkanes and mixtures thereof.

In some embodiments, at least one compatibilizer is selected to improve the compatibility of one or more lubricant with the disclosed compositions. In some embodiments, the compatibilizer is selected from the group consisting of hydrocarbons, hydrocarbon ethers, polyoxyalkylene glycol ethers (such as dipropylene glycol dimethyl ether), amides, nitriles, ketones, chlorocarbons (such as methylene chloride, trichloroethylene, chloroform, or mixtures thereof), esters, lactones, aromatic ethers, fluoroethers, 1,1,1-trifluoroalkanes, and mixtures thereof.

In some embodiments, one or more solubilizing agent and/or compatibilizer is selected from the group consisting of hydrocarbon ethers consisting of the ethers containing only carbon, hydrogen and oxygen, such as dimethyl ether (DME) and mixtures thereof. In some embodiments, the disclosed composition includes at least one compatibilizer in an amount of from about 0.5 to about 50 weight percent (based on total amount of additive used) of a linear or cyclic aliphatic or aromatic hydrocarbon compatibilizer containing from 5 to 15 carbon atoms. In some embodiments, the compatibilizer is selected from the group consisting of at least one hydrocarbon; in other embodiments, the compatibilizer is a hydrocarbon selected from the group consisting of at least pentane, hexane, octane, nonane, decane, a hydrocarbon product sold under the trademark Isopar® H (a high purity C₁₁ to C₁₂ iso-paraffinic), Aromatic 150 (a C₉ to C₁₁ aromatic), Aromatic 200 (a C₉ to C₁₅ aromatic) and Naptha 140 (all available from Exxon Chemical, USA) and mixtures thereof.

In some embodiments, the disclosed compositions include at least one polymeric compatibilizer. In some embodiments, the disclosed compositions include at least one a polymeric compatibilizer selected from those that are random copolymers of fluorinated and non-fluorinated acrylates, wherein the polymer comprises repeating units of at least one monomer represented by the formulae CH₂═C(R¹)CO₂R², CH₂═C(R³)C₆H₄R⁴, and CH₂═C(R⁵)C₆H₄XR⁶, wherein X is oxygen or sulfur; R¹, R³, and R⁵ areindependently selected from the group consisting of H and C₁—C₄ alkyl radicals; and R², R⁴, and R⁶ are independently selected from the group consisting of carbon-chain-based radicals containing C, and F, and may further contain H, Cl, ether oxygen, or sulfur in the form of thioether, sulfoxide, or sulfone groups and mixtures thereof. Examples of such polymeric compatibilizers those sold under the trademark Zonyl® PHS by E. I. du Pont de Nemours & Co., Wilmington, Del., 19898, USA. Zonyl® PHS is a random copolymer made by polymerizing 40 weight percent CH₂═C(CH₃)CO₂CH₂CH₂(CF₂CF₂)ₘF (also referred to as Zonyl® fluoromethacrylate or ZFM) wherein m is from 1 to 12, primarily 2 to 8, and 60 weight percent lauryl methacrylate (CH₂═C(CH₃)CO₂(CH₂)₁₁CH₃, also referred to as LMA).

In some embodiments, the compatibilizer component is from about 0.01 to 30 weight percent (based on total amount of compatibilizer) of an additive which reduces the surface energy of metallic copper, aluminum, steel, or other metals and metal alloys thereof found in heat exchangers in a way that reduces the adhesion of lubricants to the metal. Examples of metal surface energy reducing additives include those disclosed in WIPO PCT publication WO 96/7721, such as those products sold under the trademarks Zonyl® FSA, Zonyl® FSP and Zonyl® FSJ, all of which are products of E. I. du Pont de Nemours and Co.

In some embodiments, the disclosed compositions further include metal surface deactivators. In some embodiments, at least one metal surface deactivator is selected from the group consisting of areoxalyl bis (benzylidene) hydrazide (CAS reg no. 6629-10-3), N,N′-bis(3,5-di-tert-butyl-4-hydroxyhydrocinnamoylhydrazine (CAS reg no. 32687-78-8), 2,2,′-oxamidobis-ethyl-(3,5-di-tert-butyl-4-hydroxyhydrocinnamate (CAS reg no. 70331-94-1), N,N′-(disalicyclidene)-1,2-diaminopropane (CAS reg no. 94-91-7) and ethylenediaminetetra-acetic acid (CAS reg no. 60-00-4) and its salts, and mixtures thereof.

In some embodiments, the compositions disclosed herein further include at least one stabilizer selected from the group consisting of hindered phenols, thiophosphates, butylated triphenylphosphorothionates, organo phosphates, or phosphites, aryl alkyl ethers, terpenes, terpenoids, epoxides, fluorinated epoxides, oxetanes, ascorbic acid, thiols, lactones, thioethers, amines, nitromethane, alkylsilanes, benzophenone derivatives, aryl sulfides, divinyl terephthalic acid, diphenyl terephthalic acid, ionic liquids, and mixtures thereof. In some embodiments, said at least one stabilizer is selected from the group consisting of tocopherol; hydroquinone; t-butyl hydroquinone; monothiophosphates; and dithiophosphates, commercially available from Ciba Specialty Chemicals, Basel, Switzerland, hereinafter “Ciba”, under the trademark Irgalube® 63; dialkylthiophosphate esters, commercially available from Ciba under the trademarks Irgalube® 353 and Irgalube® 350, respectively; butylated triphenylphosphorothionates, commercially available from Ciba under the trademark Irgalube® 232; amine phosphates, commercially available from Ciba under the trademark Irgalube® 349 (Ciba); hindered phosphites, commercially available from Ciba as Irgafos® 168 and tris-(di-tert-butylphenyl)phosphite, commercially available from Ciba under the trademark Irgafos® OPH; (Di-n-octyl phosphite); and iso-decyl diphenyl phosphite, commercially available from Ciba under the trademark Irgafos® DDPP; trialkyl phosphates, such as trimethyl phosphate, triethylphosphate, tributyl phosphate, trioctyl phosphate, and tri(2-ethylhexyl)phosphate; triaryl phosphates including triphenyl phosphate, tricresyl phosphate, and trixylenyl phosphate; and mixed alkyl-aryl phosphates including isopropylphenyl phosphate (IPPP), and bis(t-butylphenyl)phenyl phosphate (TBPP); butylated triphenyl phosphates, such as those commercially available under the trademark

Syn-O-Ad® including Syn-O-Ad® 8784; tert-butylated triphenyl phosphates such as those commercially available under the trademark Durad®620; isopropylated triphenyl phosphates such as those commercially available under the trademarks Durad® 220 and Durad®110; anisole; 1,4-dimethoxybenzene; 1,4-diethoxybenzene; 1,3,5-trimethoxybenzene;

myrcene, alloocimene, limonene (in particular, d-limonene); retinal; pinene; menthol; geraniol; farnesol; phytol; Vitamin A; terpinene; delta-3-carene; terpinolene; phellandrene; fenchene; dipentene; caratenoids, such as lycopene, beta carotene, and xanthophylls, such as zeaxanthin; retinoids, such as hepaxanthin and isotretinoin; bornane; 1,2-propylene oxide; 1,2-butylene oxide; n-butyl glycidyl ether; trifluoromethyloxirane; 1,1-bis(trifluoromethyl)oxirane; 3-ethyl-3-hydroxymethyl-oxetane, such as OXT-101 (Toagosei Co., Ltd); 3-ethyl-3-((phenoxy)methyl)-oxetane, such as OXT-211 (Toagosei Co., Ltd); 3-ethyl-3-(2-ethyl-hexyloxy)methyl)-oxetane, such as OXT-212 (Toagosei Co., Ltd); ascorbic acid; methanethiol (methyl mercaptan); ethanethiol (ethyl mercaptan); Coenzyme A; dimercaptosuccinic acid (DMSA); grapefruit mercaptan (( R)-2-(4-methylcyclohex-3-enyl)propane-2-thiol)); cysteine ((R)-2-amino-3-sulfanyl-propanoic acid); lipoamide (1,2-dithiolane-3-pentanamide); 5,7-bis(1,1-dimethylethyl)-3-[2,3(or 3,4)-dimethylphenyl]-2(3H)-benzofuranone, commercially available from Ciba under the trademark Irganox® HP-136; benzyl phenyl sulfide; diphenyl sulfide; diisopropylamine; dioctadecyl 3,3′-thiodipropionate, commercially available from Ciba under the trademark Irganox® PS 802 (Ciba); didodecyl 3,3′-thiopropionate, commercially available from Ciba under the trademark Irganox® PS 800; di-(2,2,6,6-tetramethyl-4-piperidyl)sebacate, commercially available from Ciba under the trademark Tinuvin® 770; poly-(N-hydroxyethyl-2,2,6,6-tetramethyl-4-hydroxy-piperidyl succinate, commercially available from Ciba under the trademark Tinuvin® 622LD (Ciba); methyl bis tallow amine; bis tallow amine; phenol-alpha-naphthylamine; bis(dimethylamino)methylsilane (DMAMS); tris(trimethylsilyl)silane (TTMSS); vinyltriethoxysilane; vinyltrimethoxysilane; 2,5-difluorobenzophenone; 2′,5′-dihydroxyacetophenone; 2-aminobenzophenone; 2-chlorobenzophenone; benzyl phenyl sulfide; diphenyl sulfide; dibenzyl sulfide; ionic liquids; and mixtures and combinations thereof.

In some embodiments, the disclosed composition includes at least one ionic liquid stabilizer selected from the group consisting of organic salts that are liquid at room temperature (approximately 25° C.), those salts containing cations selected from the group consisting of pyridinium, pyridazinium, pyrimidinium, pyrazinium, imidazolium, pyrazolium, thiazolium, oxazolium and triazolium and mixtures thereof; and anions selected from the group consisting of [BF₄]—, [PF₆]—, [SbF₆]—, [CF₃SO₃]—, [HCF₂CF₂SO₃]—, [CF₃HFCCF₂SO₃]—, [HCCIFCF₂SO₃]—, [(CF₃SO₂)₂N]—, [(CF₃CF₂SO₂)₂N]—, [(CF₃SO₂)₃C]—, [CF₃CO₂]—, and F— and mixtures thereof. In some embodiments, e ionic liquid stabilizers are selected from the group consisting of emim BF₄ (1-ethyl-3-methylimidazolium tetrafluoroborate); bmim BF₄ (1-butyl-3-methylimidazolium tetraborate); emim PF₆ (1-ethyl-3-methylimidazolium hexafluorophosphate); and bmim PF₆ (1-butyl-3-methylimidazolium hexafluorophosphate), all of which are available from Fluka (Sigma-Aldrich).

In some embodiments, at least one stabilizer is a hindered phenol, which are any substituted phenol compound including phenols comprising one or more substituted or cyclic, straight chain, or branched aliphatic substituent group, such as, alkylated monophenols including 2,6-di-tert-butyl-4-methylphenol; 2,6-di-tert-butyl-4-ethylphenol; 2,4-dimethyl-6-tertbutylphenol; tocopherol; and the like, hydroquinone and alkylated hydroquinones including t-butyl hydroquinone, other derivatives of hydroquinone; and the like, hydroxylated thiodiphenyl ethers, including 4,4′-thio-bis(2-methyl-6-tert-butylphenol); 4,4′-thiobis(3-methyl-6-tertbutylphenol); 2,2′-thiobis(4methyl-6-tert-butylphenol); and the like, alkylidene-bisphenols including,: 4,4′-methylenebis(2,6-di-tert-butylphenol); 4,4′-bis(2,6-di-tert-butylphenol); derivatives of 2,2′- or 4,4-biphenoldiols; 2,2′-methylenebis(4-ethyl-6-tertbutylphenol); 2,2′-methylenebis(4-methyl-6-tertbutylphenol); 4,4-butylidenebis(3-methyl-6-tert-butylphenol); 4,4-isopropylidenebis(2,6-di-tert-butylphenol); 2,2′-methylenebis(4-methyl-6-nonylphenol); 2,2′-isobutylidenebis(4,6-dimethylphenol; 2,2′-methylenebis(4-methyl-6-cyclohexylphenol, 2,2- or 4,4- biphenyldiols including 2,2′-methylenebis(4-ethyl-6-tert-butylphenol); butylated hydroxytoluene (BHT, or 2,6-di-tert-butyl-4-methylphenol), bisphenols comprising heteroatoms including 2,6-di-tert-alpha-dimethylamino-p-cresol, 4,4-thiobis(6-tert-butyl-m-cresol); and the like; acylaminophenols; 2,6-di-tert-butyl-4(N,N′-dimethylaminomethylphenol); sulfides including; bis(3-methyl-4-hydroxy-5-tert-butylbenzyl)sulfide; bis(3,5-di-tert-butyl-4-hydroxybenzyl)sulfide and mixtures and combinations thereof.

In some embodiments, the disclosed compositions contain at least one tracer. In some embodiments, the tracer additive in the disclosed compositions consists of two or more tracer compounds from the same class of compounds or from different classes of compounds.

In some embodiments, the tracer component or tracer blend is present in the compositions at a total concentration of about 50 parts per million by weight (ppm) to about 1000 ppm. In other embodiments, the tracer compound or tracer blend is present at a total concentration of about 50 ppm to about 500 ppm. In other embodiment, the tracer compound or tracer blend is present at a total concentration of about 100 ppm to about 300 ppm.

In some embodiments, the disclosed compositions include at least one tracer selected from the group consisting of hydrofluorocarbons (HFCs), deuterated hydrofluorocarbons, perfluorocarbons, fluoroethers, brominated compounds, iodated compounds, alcohols, aldehydes and ketones, nitrous oxide and combinations thereof. Some embodiments of the disclosed compositions include at least one tracer selected from the group consisting of fluoroethane, 1,1,-difluoroethane, 1,1,1-trifluoroethane, 1,1,1,3,3,3-hexafluoropropane, 1,1,1,2,3,3,3-heptafluoropropane, 1,1,1,3,3-pentafluoropropane, 1,1,1,3,3-pentafluorobutane, 1,1,1,2,3,4,4,5,5,5-decafluoropentane, 1,1,1,2,2,3,4,5,5,6,6,7,7,7-tridecafluoroheptane, iodinetrifluoromethane, deuterated hydrocarbons, deuterated hydrofluorocarbons, perfluorocarbons, fluoroethers, brominated compounds, iodated compounds, alcohols, aldehydes, ketones, nitrous oxide (N₂O) and mixtures thereof. In some embodiments, the tracer additive is a tracer blend containing two or more hydrofluorocarbons, or one hydrofluorocarbon in combination with one or more perfluorocarbons.

In some embodiments, at least one tracer composition is added to the disclosed compositions in previously determined quantities to allow detection of any dilution, contamination or other alteration of the composition.

In other embodiments, the compositions disclosed herein may further include a perfluoropolyether. A common characteristic of perfluoropolyethers is the presence of perfluoroalkyl ether moieties. Perfluoropolyether is synonymous to perfluoropolyalkylether. Other synonymous terms frequently used include “PFPE”, “PFAE”, “PFPE oil”, “PFPE fluid”, and “PFPAE”. In some embodiments, the perfluoropolyether has the formula of CF₃—(CF₂)₂—O—[CF(CF₃)—CF₂—O]j′—R′f, and is commercially available from DuPont under the trademark Krytox®. In the immediately preceding formula, j′ is 2-100, inclusive and R′f is CF₂CF₃, a C3 to C6 perfluoroalkyl group, or combinations thereof.

Other PFPEs, commercially available from Ausimont of Milan, Italy, and Montedison S.p.A., of Milan, Italy, under the trademarks Fomblin® and Galden®, respectively, and produced by perfluoroolefin photooxidation, can also be used. PFPE commercially available under the trademark Fomblin®-Y can have the formula of CF₃O(CF₂CF(CF₃)—O—)_{m′}(CF₂—O—)_{n′}—R_{1f}. Also suitable is CF₃O[CF₂CF(CF₃)O]_{m′}(CF₂CF₂O)_{o′}(CF₂O)_{n′}—R_{1f}. In the formulae R_{1f} is CF₃, C₂F₅, C₃F₇, or combinations of two or more thereof; (m′+n′) is 8-45, inclusive; and m/n is 20-1000, inclusive; o′ is 1; (m′+n′+o′) is 8-45, inclusive; m′/n′ is 20-1000, inclusive.

PFPE commercially available under the trademark Fomblin®-Z can have the formula of CF₃O(CF₂CF₂—O—)_{p′}(CF₂—O)_{q′}CF₃ where (p′+q′) is 40-180 and p′/q′ is 0.5-2, inclusive.

Another family of PFPE, commercially available under the trademark Demnum™ from Daikin Industries, Japan, can also be used. It can be produced by sequential oligomerization and fluorination of 2,2,3,3-tetrafluorooxetane, yielding the formula of F—[(CF₂)₃—O]_{t′}—R_{2f} where R_{2f} is CF₃, C₂F₅, or combinations thereof and t′ is 2-200, inclusive.

In some embodiments, the PFPE is unfunctionalized. In an unfunctionalized perfluoropolyether, the end group can be branched or straight chain perfluoroalkyl radical end groups. Examples of such perfluoropolyethers can have the formula of C_{r′}F_{(2r′+1)}—A—C_{r′}F₍₂ᵣ₊₁) in which each r′ is independently 3 to 6; A can be O—(CF(CF₃)CF₂—O)_{w′}, O—(CF₂—O)_{x′}(CF₂CF₂—O)_{y′}, O—(C₂F₄—O)_{w′}, O—(C₂F₄—O)_{x′}(C₃F₆—O)_{y′}, O—(CF(CF₃)CF₂—O)_{x′}(CF₂—O)_{y′}, O—(CF₂CF₂CF₂—O)_{w′}, O—(CF(CF₃)CF₂—O)_{x′}(CF₂CF₂—O)_{y′}—(CF₂—O)_{z′}, or combinations of two or more thereof; In some embodiments, A is O—(CF(CF₃)CF₂—O)_{w′}, O—(C₂F₄—O)_{w′}, O—(C₂F₄—O)_{x′}(C₃F₆—O)_{y′}, O(CF₂CF₂CF₂—O)_{w′}, or combinations of two or more thereof; w′ is 4 to 100; x′ and y′ are each independently 1 to 100. Specific examples include, but are not limited to, F(CF(CF₃)—CF₂—O)₉—CF₂CF₃, F(CF(CF₃)—CF₂—O)₉—CF(CF₃)₂, and combinations thereof. In such PFPEs, up to 30% of the halogen atoms can be halogens other than fluorine, such as, for example, chlorine atoms.

A functionalized PFPE is a PFPE wherein at least one of the two end groups of the perfluoropolyether has at least one of its halogen atoms substituted by a group selected from esters, hydroxyls, amines, amides, cyanos, carboxylic acids, sulfonic acids or combinations thereof. In other embodiments, the two end groups of the perfluoropolyether, independently, is functionalized by the same or different groups.

In some embodiments, representative ester end groups include —COOCH₃, —COOCH₂CH₃, —CF₂COOCH₃, —CF₂COOCH₂CH₃, —CF₂CF₂COOCH₃, —CF₂CF₂COOCH₂CH₃, —CF₂CH₂COOCH₃, —CF₂CF₂CH₂COOCH₃, —CF₂CH₂CH₂COOCH₃, —CF₂CF₂CH₂CH₂COOCH₃.

In some embodiments, representative hydroxyl end groups include —CF₂OH, —CF₂CF₂OH, —CF₂CH₂OH, —CF₂CF₂CH₂OH, —CF₂CH₂CH₂OH, —CF₂CF₂CH₂CH₂OH.

In some embodiments, representative amine end groups include —CF₂NR¹R², —CF₂CF₂NR¹R², —CF₂CH₂NR¹R², —CF₂CF₂CH₂NR¹R², —CF₂CH₂CH₂NR¹R², —CF₂CF₂CH₂CH₂NR¹R², wherein R¹ and R² are independently H, CH₃, or CH₂CH₃.

In some embodiments, representative amide end groups include —CF₂C(O)NR¹R², —CF₂CF₂C(O)NR¹R², —CF₂CH₂C(O)NR¹R², —CF₂CF₂CH₂C(O)NR¹R², —CF₂CH₂CH₂C(O)NR¹R², —CF₂CF₂CH₂CH₂C(O)NR¹R², wherein R¹ and R² are independently H, CH₃, or CH₂CH₃.

In some embodiments, representative cyano end groups include —CF₂CN, —CF₂CF₂CN, —CF₂CH₂CN, —CF₂CF₂CH₂CN, —CF₂CH₂CH₂CN, —CF₂CF₂CH₂CH₂CN.

In some embodiments, representative carboxylic acid end groups include —CF₂COOH, —CF₂CF₂COOH, —CF₂CH₂COOH, -—CF₂CF₂CH₂COOH, —CF₂CH₂CH₂COOH, —CF₂CF₂CH₂CH₂COOH.

In some embodiments, the sulfonic acid end groups is selected from the group consisting of —S(O)(O)OR³, —S(O)(O)R⁴, —CF₂O S(O)(O)OR³, —CF₂CF₂O S(O)(O)OR³, —CF₂CH₂O S(O)(O)OR³, —CF₂CF₂CH₂O S(O)(O)OR³, —CF₂CH₂CH₂O S(O)(O)OR³, —CF₂CF₂CH₂CH₂O S(O)(O)OR³, —CF₂ S(O)(O)OR³, —CF₂CF₂ S(O)(O)OR³, —CF₂CH₂ S(O)(O)OR³, —CF₂CF₂CH₂ S(O)(O)OR³, —CF₂CH₂CH₂ S(O)(O)OR³, —CF₂CF₂CH₂CH₂ S(O)(O)OR³, —CF₂O S(O)(O)R⁴, —CF₂CF₂O S(O)(O)R⁴, —CF₂CH₂O S(O)(O)R⁴, —CF₂CF₂CH₂O S(O)(O)R⁴, —CF₂CH₂CH₂O S(O)(O)R⁴, —CF₂CF₂CH₂CH₂O S(O)(O)R⁴, wherein R³ is H, CH₃, CH₂CH₃, CH₂CF₃, CF₃, or CF₂CF₃, R⁴ is CH₃, CH₂CH₃, CH₂CF₃, CF₃, or CF₂CF₃.

In some embodiments, the disclosed compositions include additives that are members of the triaryl phosphate family of EP (extreme pressure) lubricity additives, such as butylated triphenyl phosphates (BTPP), or other alkylated triaryl phosphate esters, e.g. Syn-0-Ad® 8478 from Akzo Chemicals, tricresyl phosphates and related compounds. Additionally, the metal dialkyl dithiophosphates (e.g., zinc dialkyl dithiophosphate (or ZDDP), Lubrizol 1375 and other members of this family of chemicals is used in compositions of the disclosed compositions. Other antiwear additives include natural product oils and asymmetrical polyhydroxyl lubrication additives, such as Synergol TMS (International Lubricants).

In some embodiments, stabilizers such as antioxidants, free radical scavengers, and water scavengers and mixtures thereof are included. Such additives in this category can include, but are not limited to, butylated hydroxy toluene (BHT), epoxides, and mixtures thereof. Corrosion inhibitors include dodecyl succinic acid (DDSA), amine phosphate (AP), oleoyl sarcosine, imidazone derivatives and substituted sulfphonates. Metal surface deactivators include areoxalyl bis (benzylidene) hydrazide (CAS reg no. 6629-10-3), N,N′-bis(3,5-di-tert-butyl-4-hydroxyhydrocinnamoylhydrazine (CAS reg no. 32687-78-8), 2,2,′-oxamidobis-ethyl-(3,5-di-tert-butyl-4-hydroxyhydrocinnamate (CAS reg no. 70331-94-1), N,N′-(disalicyclidene)-1,2-diaminopropane (CAS reg no. 94-91-7) and ethylenediaminetetra-acetic acid (CAS reg no. 60-00-4) and its salts, and mixtures thereof.

In some embodiments, the disclosed compositions maintain their non-flammable properties even when experiencing vapor or liquid leakage during use in a heat transfer system.

In some embodiments, the disclosed compositions provide adequate (or the required level of) oil return to the compressor when using conventional mineral oil. In some embodiments, the disclosed compositions provide greater oil-return to the compressor when using conventional mineral oil, as compared to systems using R134a alone.

As used herein, the term heat transfer composition means a composition used to carry heat from a heat source to a heat sink.

A heat source is defined as any space, location, object or body from which it is desirable to add, transfer, move or remove heat. Examples of heat sources are spaces (open or enclosed) requiring refrigeration or cooling, such as refrigerator or freezer cases in a supermarket, building spaces requiring air-conditioning, industrial water chillers or the passenger compartment of an automobile requiring air-conditioning.

A heat sink is defined as any space, location, object or body capable of absorbing heat. A vapor compression refrigeration system is one example of such a heat sink.

A heat transfer system is the system used to produce a heating or cooling effect in a particular space.

Examples of heat transfer systems include but are not limited to air conditioners, freezers, refrigerators, heat pumps, water chillers, flooded evaporator chillers, direct expansion chillers, walk-in coolers, heat pumps, mobile refrigerators, mobile air conditioning units and combinations thereof.

As used herein, mobile refrigeration apparatus, mobile air conditioning or mobile heating apparatus refers to any refrigeration, air conditioner, or heating apparatus incorporated into a transportation unit for the road, rail, sea or air. In addition, mobile refrigeration or air conditioner units, include those apparatus that are independent of any moving carrier and are known as “intermodal” systems. Such intermodal systems include “containers” (combined sea/land transport) as well as “swap bodies” (combined road/rail transport).

As used herein, stationary heat transfer systems are systems associated within or attached to buildings of any variety. These stationary applications may be stationary air conditioning and heat pumps (including but not limited to chillers, high temperature heat pumps, residential, commercial or industrial air conditioning systems, and including window, ductless, ducted, packaged terminal, chillers, and those exterior but connected to the building such as rooftop systems). In stationary refrigeration applications, the disclosed compositions may be useful in equipment including commercial, industrial or residential refrigerators and freezers, ice machines, self-contained coolers and freezers, flooded evaporator chillers, direct expansion chillers, walk-in and reach-in coolers and freezers, and combination systems. In some embodiments, the disclosed compositions may be used in supermarket refrigerator systems.

Refrigeration capacity (sometimes referred to as cooling capacity) is a term to define the change in enthalpy of a refrigerant in an evaporator per pound of refrigerant circulated, i.e., the heat removed by the refrigerant in the evaporator per a given time. The refrigeration capacity is a measure of the ability of a refrigerant or heat transfer composition to produce cooling. Therefore, the higher the capacity the greater the cooling that is produced.

Coefficient of performance (COP) is the amount of heat removed divided by the required energy input to operate the cycle. The higher the COP, the higher the energy efficiency. COP is directly related to the energy efficiency ratio (EER) that is the efficiency rating for refrigeration or air conditioning equipment at a specific set of internal and external temperatures.

The term “subcooling” means the reduction of the temperature of a liquid below that liquid's saturation point for a given pressure. The saturation point is the temperature at which the vapor usually would condense to a liquid, but subcooling produces a lower temperature liquid at the given pressure. By cooling a liquid below the saturation point, the net refrigeration capacity can be increased. Subcooling thereby improves refrigeration capacity and energy efficiency of a system.

Superheat is a term defining how far above its saturation vapor temperature a vapor composition is heated.

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100 year time horizon is commonly the value referenced. For mixtures, a weighted average can be calculated based on the individual GWP values for each component of the mixture.

Ozone depletion potential (ODP) means the definition provided in “The Scientific Assessment of Ozone Depletion, 2002, A report of the World Meteorological Association's Global Ozone Research and Monitoring Project,” section 1.4.4, pages 1.28 to 1.31. ODP represents the extent of ozone depletion in the stratosphere expected from a compound on a mass-for-mass basis relative to fluorotrichloromethane (CFC-11).

As used herein, the term “lubricant” means any material added to a composition or a compressor (and in contact with any heat transfer composition in use within any heat transfer system) that provides lubrication to the compressor.

As used herein, compatibilizers are compounds which improve solubility of the hydrofluorocarbon of the disclosed compositions in heat transfer system lubricants. In some embodiments, the compatibilizers improve oil return to the compressor. In some embodiments, the composition is used with a system lubricant to reduce oil-rich phase viscosity.

As used herein, oil-return refers to the ability of a heat transfer composition to carry lubricant through a heat transfer system and return it to the compressor. That is, in use, it is not uncommon for some portion of the compressor lubricant to be carried away from the compressor by the heat transfer composition into the other portions of the system. In such systems, if the lubricant is not efficiently returned to the compressor, the compressor will eventually fail due to lack of lubrication.

Flammability is a term used to mean the ability of a composition to ignite and/or propagate a flame. For refrigerants and other heat transfer compositions, the lower flammability limit (“LFL”) is the minimum concentration of the heat transfer composition in air that is capable of propagating a flame through a homogeneous mixture of the composition and air under test conditions specified in ASTM (American Society of

Testing and Materials) E681-2001. The test data indicates if the composition is flammable in the liquid phase or in the vapor phase present in a closed container above the liquid at specified temperatures (as designated by ASHRAE (American Society of Heating, Refrigerating and Air-Conditioning Engineers) in ASHRAE Standard 34-2007). In order to be classified by ASHRAE as non-flammable, a refrigerant must be non-flammable under the conditions of ASTM E681-2001 as formulated in both the liquid and vapor phase as well as during leakage scenarios.

As used herein, “ultra-violet” dye is defined as a UV fluorescent or phosphorescent composition that absorbs light in the ultra-violet or “near” ultra-violet region of the electromagnetic spectrum. The fluorescence produced by the UV fluorescent dye under illumination by a UV light that emits at least some radiation with a wavelength in the range of from about 10 nanometers to about 775 nanometers may be detected.

Advantages to some embodiments include improved (reduced) lubricant viscosity, improved oil-return in use in vapor compression heat transfer systems, superior solubility with mineral oil while remaining below industry acceptable flammability performance.

In many applications, some embodiments of the disclosed compositions are useful as refrigerants and provide at least comparable cooling performance (meaning cooling capacity and energy efficiency) as the refrigerant for which a replacement is being sought.

Embodiments of the compositions disclosed herein have heat transfer capacity performance suitable for replacement of R12 (dichlorodifluoromethane), R134a, and R413A (the ASHRAE designation for a blend of 88 weight percent R134a, 9 weight percent R218 (octafluoropropane), and 3 weight percent isobutane).

Some embodiments of the above disclosed compositions are suitable as replacement compositions for R12, R134a, and R413A. R12, R134a, and R413A are often used in automotive air-conditioning systems, stationary air-conditioning systems, as well as direct expansion stationary medium temperature refrigeration systems, such as food service, supermarket display cases, food storage and processing, and domestic refrigerators or freezers.

In some embodiments, the compositions disclosed herein are useful for any positive displacement compressor system designed for any number of heat transfer compositions including refrigerants R12, R134a, and R413A. Additionally, many of the compositions disclosed are useful in new equipment utilizing positive displacement compressors to provide similar performance to the aforementioned refrigerants. In some embodiments, the disclosed compositions have unexpected and improved performance in terms of the combined characteristics of non-flammability, refrigeration capacity, energy efficiency, and mineral oil viscosity reduction.

Also disclosed herein is a process to produce cooling comprising condensing a composition as disclosed herein and thereafter evaporating said composition in the vicinity of a body to be cooled.

In some embodiments, the use of the above disclosed compositions includes using the composition as a heat transfer composition in a process to produce heat comprising condensing a composition as disclosed herein in the vicinity of a body to be heated and thereafter evaporating said composition.

In some embodiments, the use of the above disclosed compositions includes using the composition as a heat transfer composition in a process for producing cooling, wherein the composition is first cooled and stored under pressure and when exposed to a warmer environment, the composition absorbs some of the ambient heat, expands, and the warmer environment is thusly cooled.

In another embodiment is provided a method for recharging a heat transfer system that contains a refrigerant to be replaced and a lubricant, said method comprising removing the refrigerant to be replaced from the heat transfer system while retaining a substantial portion of the lubricant in said system and introducing one of the herein disclosed compositions to the heat transfer system.

In another embodiment, a heat exchange system comprising a composition disclosed herein is provided, wherein said system is selected from the group consisting of air conditioners, freezers, refrigerators, heat pumps, water chillers, flooded evaporator chillers, direct expansion chillers, walk-in coolers, heat pumps, mobile refrigerators, mobile air conditioning units, and systems having combinations thereof.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim such would closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed provided that these additional included materials, steps, features, components, or elements do materially affect the basic and novel characteristic(s) of the claimed invention. The term ‘consisting essentially of’ occupies a middle ground between “comprising” and ‘consisting of’.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the disclosed compositions, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

### EXAMPLES

The concepts disclosed herein will be further described in the following examples, which do not limit the scope of the invention described in the claims.

### Flammability

Flammability of a composition is determined by the method and at conditions as described in ASTM E681-2001 and in ASHRAE Standard 34-2007. The compositions below were tested under these conditions to determine if flammable in liquid phase or vapor phase, finding that the most flammable composition is that of the vapor phase at 10° C. above the normal boiling point of about -−32° C.

TABLE 1

| | Flam. | | | Flam. |
|---|---|---|---|---|
| | Liquid | | | Vapor |
| | phase | Temp. | Vapor phase | phase |
| Liquid Composition | (yes/no?) | (° C.) | composition | (yes/no?) |
| Comparative | | | | |
| composition | | | | |
| R125/R134a/n-butane | No | −22 | 30.5/65.1/ | Yes |
| (16.6/81/2.4 wt %) | | | 4.4 wt % | |
| Selected Embodiment | | | | |
| of the composition | | | | |
| disclosed herein | | | | |
| R125/R134a/n-butane | No | −23 | 35.1/61.7/ | No |
| (19.5/78.9/1.6 wt %) | | | 3.2 | |

It can be seen from Table 1 that a liquid composition containing 2.4 weight percent n-butane was found to produce a flammable composition in the vapor phase at −22° C. even though the original formulation was not flammable. The composition containing only 1.6 weight percent n-butane did not produce a flammable composition in the vapor.

### Oil-Return

To evaluate oil-return improvement of differing amounts of hydrocarbon in R125/R134a/n-butane mixtures, a level tube was installed to determine the level of oil in the compressor oil sump of a domestic refrigerator.

During start-up of a system, the oil level normally decreases as refrigerant carries some amount of lubricant out into the system. If there is adequate solubility of refrigerant in the lubricant to reduce lubricant viscosity, the oil will be carried through the heat exchangers and back to the oil sump, maintaining an adequate amount of oil for compressor lubrication. Testing in a Frigidaire® refrigerator (Model FRT21 P5AW6 topmount 21-cubic-foot domestic refrigerator manufactured in August 2002) showed that lubricant level in the oil sump was lost when the system was operated with R134a and Suniso® 1GS mineral oil and also for a composition containing 20.2 weight percent R125, 79.3 weight percent R134a, and only 0.5 weight percent n-butane. However, lubricant level was maintained at an adequate level for operation with a composition containing 20.0 weight percent R125, 79.0 weight percent R134a, and 1.0 weight percent n-butane. Therefore, compositions as disclosed herein containing at least 1.0 weight percent n-butane provide the required oil return behavior for proper operation of the compressor in this domestic refrigerator.

### Refrigerator Cooling Performance Data

Table 2 shows the performance data for a composition as disclosed herein compared to the same measured performance characteristics for R413A and R134a in a refrigerator.

In Table 2, EER is energy efficiency and capacity is cooling capacity in kBTU/hr. Compressor cut-out temperature is the temperature point in the evaporator at which the compressor will stop operation. Compressor cut-in temperature is the temperature point in the evaporator at which the compressor will re-start operation. The data was collected from a McCall refrigerator (Model 2-2045GD refrigerator) containing the composition as shown in Table 2 run under the following conditions.

| | | |
|---|---|---|
| Ambient air temperature | 90° F. | (32° C.) |
| Internal refrigerator temperature | 38° F. | (3° C.) |
| Compressor cut-out temperature | 33.5° F. | (1° C.) |
| Compressor cut-in temperature | 42.5° F. | (6° C.) |

TABLE 2

| | | Capacity |
|---|---|---|
| Composition | EER | (kBTU/hr) |
| R134a | 3.10 | 3.27 |
| R413A | 2.96 | 3.21 |
| R125/R134a/n-butane | 2.95 | 3.23 |
| (19.5/78.9/1.6 wt %) | | |

The above data demonstrates that the above disclosed composition is suitable for retrofit of systems using or designed to use R134a and R413A in that they provide similar energy efficiency (EER) and cooling capacity.

### Mobile Air Conditioner Cooling Performance

Table 3 shows the performance data for a composition as disclosed herein compared to the same measured performance characteristics for R413A and R134a in a mobile air-conditioner system.

In Table 3, COP is energy efficiency and capacity is cooling capacity. GPL-104 is a perfluoropolyether additive sold under the trademark Krytox® GPL-104 (E.I. DuPont de Nemours, Wilmington, Del.) and is added to the disclosed composition in amount of 0.2 weight percent. COP and cooling capacity were measured for a mobile air conditioning system from a Volkswagen Golf V (Volkswagen AG, in Wolfsburg, Germany) containing the composition as shown in Table 3, run at ambient air temperature of 90° F. (32 ° C.) and an engine speed of 1000 rpm.

TABLE 3

| Composition | COP | Capacity, kBTU/hr |
|---|---|---|
| R134a | 2.0 | 1900 |
| R413A | 1.95 | 1900 |
| R125/R134a/n-butane | 2.1 | 1900 |
| (19.5/78.9/1.6 wt %) | | |
| plus 0.2 wt % GPL-104 | | |

The above data demonstrates that the above disclosed composition can match the performance of R134a in terms of energy efficiency (COP) and cooling capacity and has a higher COP than R413A in the mobile air conditioner test.

### Cooling Performance

Table 4 shows cooling performance, as energy efficiency (COP), compressor discharge pressure (Dis Press), compressor suction pressure (Suct Press), and compressor discharge temperature (Dis T) for several compositions disclosed herein for medium temperature refrigeration systems.

The data for the disclosed compositions is calculated using Cycle D thermodynamic cycle calculation software program available from the U.S. National Institute of Standards and Technology, version 2.2 (1998) based on the following conditions:

| Average evaporator temperature | 0° | C. |
|---|---|---|
| Average condenser temperature | 40.0° | C. |
| Amount of subcooling | 2.0° | C. |
| Amount of superheat | 2.0° | C. |
| Compressor isentropic efficiency | 70% | |
| Cooling capacity | 10 | kilowatts |

TABLE 4

| | | Dis | Suct | |
|---|---|---|---|---|
| Weight Percent, | | Press | Press | Dis T |
| R125/R134a/n-butane | COP | (kPa) | (kPa) | (° C.) |
| 17.0/81.0/2.0 | 3.67 | 1152 | 321 | 57.6 |
| 22.0/77.0/1.0 | 3.61 | 1199 | 331 | 58.0 |
| 18.0/80.4/1.6 | 3.66 | 1162 | 323 | 57.7 |
| 21.0/77.4/1.6 | 3.63 | 1188 | 329 | 57.8 |
| 19.0/79.4/1.6 | 3.65 | 1171 | 325 | 57.7 |
| 20.0/78.4/1.6 | 3.64 | 1179 | 327 | 57.8 |

The data in Table 4 shows that the composition ranges described herein demonstrate similar cooling performance in terms of energy efficiency (COP), discharge pressures and temperatures.

### Global Warming Potential

Global warming potentials (GWPs) are provided in Table 5 below for one of the disclosed compositions containing R125, R134a and n-butane as compared to R134a and R413A.

SAR GWP values are those taken from or calculated as a weighted average from the data reported in the Second Assessment Report (1995) of the Intergovernmental Panel on Climate Change (using a 100 year time horizon) for HFCs, the SAR values have been adopted for the purposes of compliance with the Kyoto Protocol.

All blends listed below have a zero ozone depletion rating pursuant to “The Scientific Assessment of Ozone Depletion, 2002, A report of the World Meteorological Association's Global Ozone Research and Monitoring Project,” section 1.4.4, page 1.30 Table 1-5 as reported for the Montreal Protocol.

TABLE 5

| | GWP | |
|---|---|---|
| Composition | (SAR*) | ODP |
| R12 | 8100 | 1 |
| R134a | 1300 | 0 |
| R413A | 1800 | 0 |
| (R134a/R218/isobutane) | | |
| 88/9/3 wt % | | |
| R417A | 1955 | 0 |
| R125/R134a/n-butane | | |
| (46.6/50/3.4 wt %) | | |
| One Disclosed Composition | 1600 | 0 |
| R125/R134a/n-butane | | |
| (19.5/78.9/1.6 wt %) | | |

In the foregoing specification, the concepts have been disclosed with reference to specific embodiments. However, one of ordinary skill in the art appreciates that various modifications and changes can be made without departing from the scope of the invention as set forth in the claims below.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all embodiments.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

What is claimed is:

1. A composition consisting essentially of:
about 17.0 weight percent to about 22.0 weight percent pentafluoroethane;
about 77.0 weight percent to about 81.0 weight percent 1,1,1,2-tetrafluoroethane; and
about 1.0 weight percent to about 2.0 weight percent of n-butane.

2. The composition of claim 1 consisting essentially of:
about 18.0 weight percent to about 21.0 weight percent pentafluoroethane;
about 77.4 weight percent to about 80.4 weight percent 1,1,1,2-tetrafluoroethane; and
about 1.2 weight percent to about 1.9 weight percent of n-butane.

3. The composition of claim 1 consisting essentially of:
about 18.5 weight percent to about 20.5 weight percent pentafluoroethane;
about 77.9 weight percent to about 79.9 weight percent 1,1,1,2-tetrafluoroethane; and
about 1.3 weight percent to about 1.8 weight percent of n-butane.

4. The composition of claim 1 consisting essentially of:
about 19.0 weight percent to about 20.0 weight percent pentafluoroethane;
about 78.4 weight percent to about 79.4 weight percent 1,1,1,2-tetrafluoroethane; and
about 1.4 weight percent to about 1.7 weight percent of n-butane.

5. A composition consisting essentially of:
about 17.0 weight percent to about 22.0 weight percent pentafluoroethane;
about 77.0 weight percent to about 81.0 weight percent 1,1,1,2-tetrafluoroethane;
about 1.0 weight percent to about 2.0 weight percent of n-butane; and
at least one additive.

6. The composition according to claim 5, wherein the composition includes at least one additive selected from the group consisting of mineral oils, synthetic lubricants and mixtures thereof.

7. The composition according to claim 5, wherein the composition includes
at least one additive selected from the group consisting of lubricants, dyes, solubilizing agents, compatibilizers, stabilizers, tracers, perfluoropolyethers, anti wear agents, extreme pressure agents, corrosion and oxidation inhibitors, metal surface deactivators, free radical scavengers, foam control agents, viscosity index improvers, pour point depressants, detergents, viscosity adjusters, and mixtures thereof.

8. The composition of claim 5, wherein the composition includes
at least one lubricant selected from the group consisting of mineral oils, alkylbenzene lubricants, polyalkylene glycols, polyol esters, and fluorinated oils and mixtures thereof; and
at least one additive selected from the group consisting of UV dyes, solubilizing agents, compatibilizers, stabilizers, tracers, perfluoropolyethers, functionalized perfluoropolyethers, anti wear agents, extreme pressure agents, corrosion and oxidation inhibitors, metal surface deactivators, free radical scavengers, foam control agents, viscosity index improvers, pour point depressants, detergents, viscosity adjusters, and mixtures thereof.

9. The composition according to claim 5, wherein the additive is from about 0.1 to about 5.0% by weight of the composition.
